(19) United States
(12) Patent Application Publication
(10) Pub. No.: US 2006/0075170 A1
(43) Pub. Date: Apr. 6, 2006

(54) System and method for high voltage bidirectional communications interface

(75) Inventors: Eileen M. Behrendt, Mahopac, NY (US); Jeffrey R. Biamonte, Hyde Park, NY (US); Raymond J. Harrington, Staatsburg, NY (US); Robert B. Schlak, Hyde Park, NY (US); Timothy M. Trifilo, Poughkeepsie, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: International Business Machines Corporation, Armonk, NY (US)

(21) Appl. No.: 10/954,750

(22) Filed: Sep. 30, 2004

(51) Int. Cl. G06F 13/00

(52) U.S. Cl. 710/110

(57) ABSTRACT

A system and method for providing an interface between a master device referenced at a first voltage and a slave device referenced at a second voltage. The system includes a bidirectional communications link between the master device and the slave device and a bidirectional transceiver device in the communications link for decomposing bidirectional signals on the communications link into transmissions from the slave device to the master device onto a first bus, and transmissions from the master device to the slave device onto a second bus. A first isolation device is included in the bidirectional link and connected to the first bus for transmitting signals over the bidirectional link from the master device referenced at the first voltage to the slave device referenced at the second voltage. A second isolation device in also included in the bidirectional link and connected to the second bus for transmitting signals over the bidirectional link from the slave device referenced at the second voltage to the master device referenced at the first voltage.

### CROSS REFERENCE TO RELATED APPLICATIONS

This application contains subject matter which is related to the subject matter of the following applications, which are assigned to the same assignee as this application and which are hereby incorporated herein by reference by their entirety:

“Method and System For Providing Bidirectional Asynchronous Communication”, Barus et al., Ser. No. 10/668,488 filed Mar. 23, 2003;

“System, Method and Program Product for Extending Range of a Bidirectional Data Communication Bus”, Behrendt et al., Ser. No. 10/838391 filed May 4, 2004.

### TECHNICAL FIELD

The present invention relates to data communication, and in particular, to a system and method for providing bidirectional half duplex communications signals between two devices. Embodiments of the invention provide the ability for the mentioned signals to traverse voltage boundaries with different ground references, thus providing greater safety and signal integrity.

### BACKGROUND OF THE INVENTION

Existing complex programmable logic devices (CPLD), field programmable gate array (FPGA), and application specific integrated circuit (ASIC) technologies do not directly support implementation of internal bidirectional signals without the use of a dedicated direction control signal. Current architectures allow for I/O pins to be configured as bidirectional signals. However, these architectures do not allow for two of these pins to be directly tied together while maintaining a truly asynchronous bidirectional data path. The only existing solution to this unique problem is the introduction of a data direction control signal, which makes asynchronous bidirectional communication impossible.

A common method of implementing an asynchronous bidirectional half duplex communications link is the use of an open drain or open collector driver and a logic receiver at each end of the communications link which has a pull up resistor to a common voltage. It is possible for multiple devices to be connected to the same link. In the case of multiple devices on the same link, when one device talks, all other devices on the net receive the message. In this case, an agreed means of addressing is used so that an intended recipient knows the message is for him. At times it is desirable or necessary to isolate certain devices on such a link. This can arise because multiple devices may share the same address or there may not be enough addresses to accommodate the number of devices. Alternately it may be desirable to isolate a failing device from the link so that the failing device does not render the link inoperative. Many other instances arise where it is desirable to be able to inexpensively route and manipulate such communications links. Typically open drain and open collector communication links can be isolated, switched and routed using analog switches. Analog switches are large and expensive and this limits the complexity of the switching which can be easily achieved. Therefore, it is desirable to be able to switch and route such signals using logic gates which could reside on a CPLD, FPGA, ASIC or other highly integrated, inexpensive device.

Common system management buses, such as I²C and SM Busses, fall short in their ability to be transmitted across high voltage isolation boundaries. The inherent open collector architecture of these busses provides that any item on the bus brings the bus state to ground. An isolation boundary implies two different ground references. It should be noted that this invention is different than traditional serial interfaces in which transmit and receive lines are present. For example, a standard full duplex UART can simply transmit and receive data across an isolation boundary using optical couplers. In the present invention, optical couplers are used to provide isolation whereas typically, optical couplers are inherently viewed as single direction devices and therefore are not applicable for use with a bidirectional half duplex data line.

### SUMMARY OF THE INVENTION

The shortcomings of the prior art are overcome and additional advantages are provided through a communication system for isolating and level shifting of a bidirectional data communication bus between a first device and a second device. The communication system includes decomposition logic for decomposing the bidirectional data communication bus into a unidirectional transmit data communication bus and a unidirectional receive data communication bus. An optoisolator can then be used to transmit the unidirectional transmit data communication bus and the unidirectional receive data communication bus thereby providing electrical isolation and level shifting, and recomposition circuitry is connected to the optoisolated communication subsystem for recombining the isolated unidirectional transmit data communication bus and the isolated unidirectional receive data communication bus into the bidirectional data communication bus.

In another aspect, a system is provided which includes a first device having a bidirectional first input/output pin and a second device having a bidirectional second input/output pin. The system further includes a communication system coupling the bidirectional first input/output pin with the bidirectional second input/output pin without a data direction control line therebetween. The communication system includes an optically isolated bidirectional data communication bus wherein a portion of the bidirectional data communication bus is decomposed into unidirectional transmit and receive data communication buses which are optically isolated employing an isolated communication subsystem.

In the yet further aspect, at least one program storage device readable by a machine, tangibly embodying at least one program of instructions executable by the machine is provided to perform a method of optically isolating a bidirectional data communication bus between a first device and a second device. The method includes: decomposing the bidirectional data communication bus into a unidirectional transmit data communication bus and a unidirectional receive data communication bus; employing an optically isolated communication subsystem to electrically isolate the unidirectional transmit data communication bus and electrically isolate the unidirectional receive data communication bus; and reestablishing the bidirectional data communication bus by recombining the extended unidirectional transmit data communication bus and the extended unidirectional receive data communication bus.

A further aspect of the invention provides an I²C bus implemented in a programmable logic device, where control signals are available to facilitate a robust high voltage noise immune interface while maintaining full software compatibility with the well known I²C specification. Although the invention is embodied in connection with an I²C bus as an example, it will be understood that the invention may be applied to any generic half duplex resistively pulled up communications scheme.

A method and system is presented to allow bidirectional, one-wire, open-collector (drain) signals to traverse voltage boundaries with different ground potentials using a novel configuration of conventional components as well as custom logic implemented in a CPLD or FPGA. The current invention allows such signals to traverse the abovementioned boundaries, and is particularly useful as system distribution voltages increase. For example, high voltage distribution systems for midrange and high-end computers, as well as the high voltage bus present in electric vehicles, necessitate a safe, drop-in solution to use simple and well established busses in connection with new environments.

The present invention also provides a system which is invulnerable to ground potential shift and other common mode anomalies. Safety isolation by use of optical isolation, widely recognized as being acceptable by worldwide safety agencies, is also achieved by the proposed embodiment of this invention.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an exemplary bidirectional communication system between two devices;

FIGS. 2A and 2B depict asynchronous encoder logic for first and second transceivers;

FIG. 3 depicts Karnaugh maps for the encoder logic;

FIG. 4 depicts an exemplary state transition table for the communication system of FIG. 1;

FIG. 5 depicts an exemplary state diagram for the communication system of FIG. 1;

FIG. 6 depicts an exemplary sequence of events and corresponding state transitions;

FIG. 7 is a high level block diagram of the state machine provided by the communication system of FIG. 1;

FIG. 8 is a block diagram of one embodiment of a communication system for extending range of a bidirectional data communication bus

FIG. 9 is an example embodiment of the system of FIG. 1 depicting the Safety Extra Low Voltage (GND A) boundary; and

FIG. 10 depicts the system of FIG. 1 including a pair of optical isolation devices for crossing the GND A boundary of FIG. 8.

### BEST MODE FOR CARRYING OUT THE INVENTION

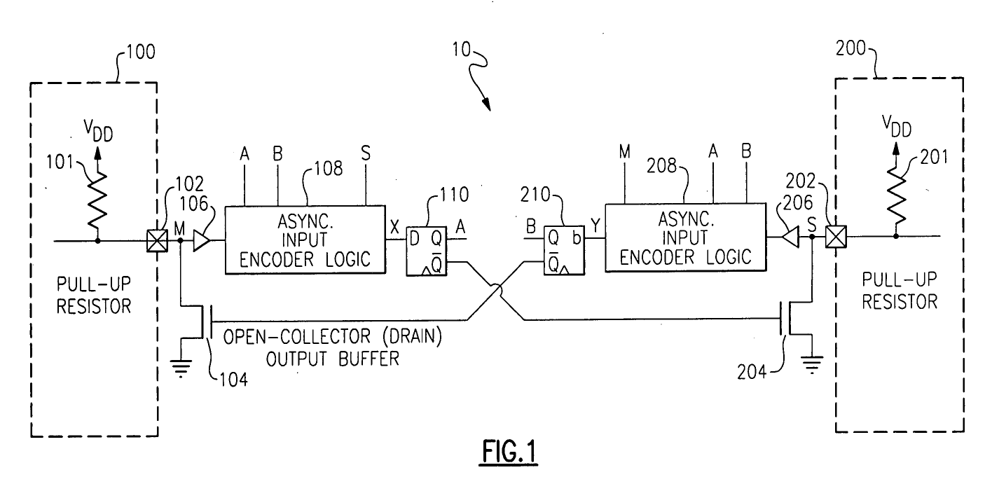

FIG. 1 depicts an exemplary bidirectional communications system 10 between two devices, shown as first device 100 and second device 200. The designations first and second are for identification purposes only. The first and second designations do not indicate that one device has access priority to the communication bus or controls all communications between the two devices. Each device 100 and 200 includes a bidirectional input/output (I/O) pin 102 and 202, respectively. The input/output pins are pulled to logic high by pull-up resistors 101 and 201, respectively.

The communication system includes a first bus driver 104 and a second bus driver 204. The first signal M is provided to an input buffer 106 and then to first asynchronous encoder logic 108. The first asynchronous encoder logic 108 receives the first signal M, current first state A, current second state B and second signal S and generates a next first state X. The next first state X is provided to gate 110 (e.g., D flip flop) that outputs the next first state X as the current first state on the state machine clock. The current first state A is fed back as an input to the first asynchronous encoder logic 108 and second asynchronous encoder logic 208. Gate 110 also generates an inverted second drive signal which is provided to second bus driver 204. The second bus driver 204 connects the input/output pin 202 to ground and may be a switch element such as a BJT (i.e., in open collector configuration), FET (i.e., in open drain configuration), etc. The second drive signal activates second bus driver 204 that connects the input/output pin 202 to ground. As described in further detail herein, this corresponds to first device 100 sending a logic low to second device 200.

The second signal S is provided to an input buffer 206 and then to second asynchronous encoder logic 208. The second asynchronous encoder logic 208 receives the first signal M, current first state A, current second state B and second signal S and generates a next second state Y. The next second state Y is provided to gate 210 (e.g., D flip flop) that outputs the next second state Y as the current second state B on the state machine clock. Current second state B is fed back as an input to the first asynchronous encoder logic 108 and second asynchronous encoder logic 208. Gate 210 also generates an inverted first drive signal which is provided to first bus driver 104. The first bus driver 104 that connects the input/output pin 102 to ground and may be a switch element such as a BJT (i.e., in open collector configuration), FET (i.e., in open drain configuration), etc. The first drive signal activates first bus driver 104 connects the input/output pin 102 to ground. As described in further detail herein, this corresponds to second device 200 sending a logic low to first device 100.

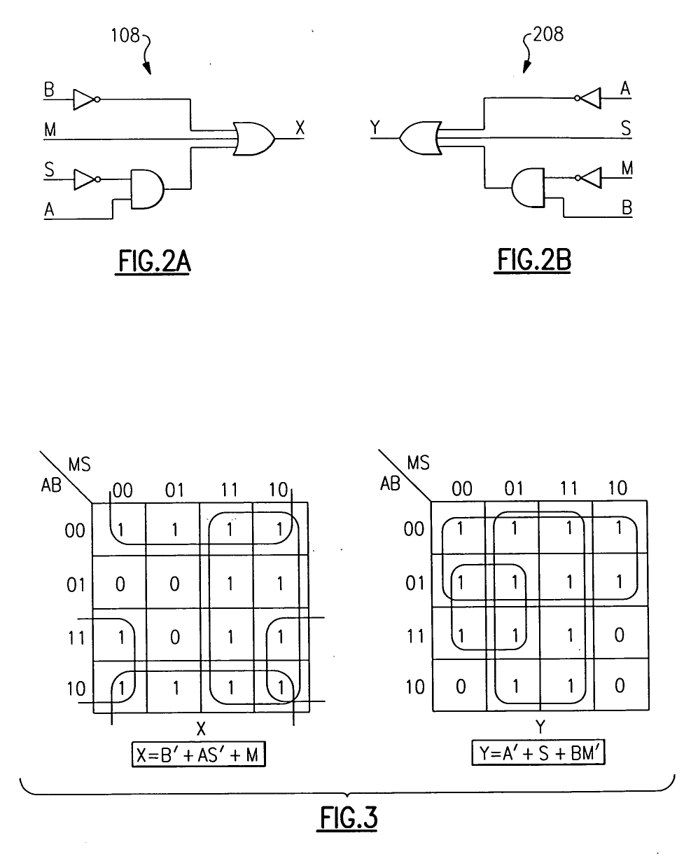

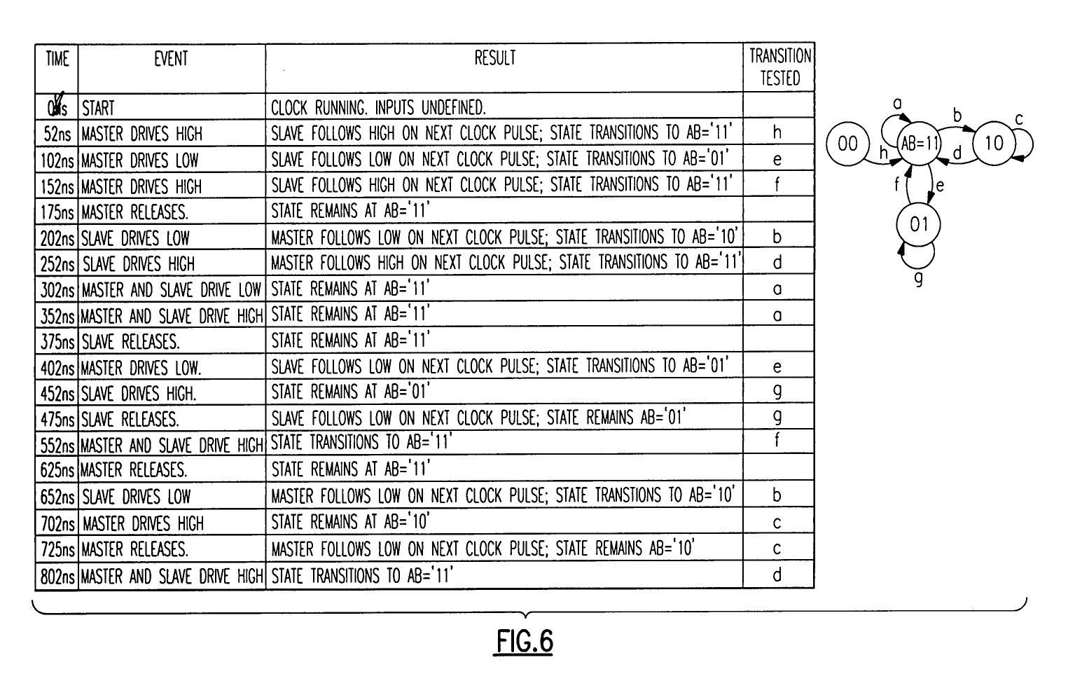

FIG. 2A depicts an exemplary embodiment for the first asynchronous encoder logic 108. The first asynchronous encoder logic 108 includes a number of logic gates that drive the next first state X. The various states and transitions are described in further detail with reference to FIG. 5. FIG. 2B depicts an exemplary embodiment for the second asynchronous encoder logic 208. The second asynchronous encoder logic 208 includes a number of logic gates that drive the next second state Y. The various states and transitions are described in further detail with reference to FIG. 5.

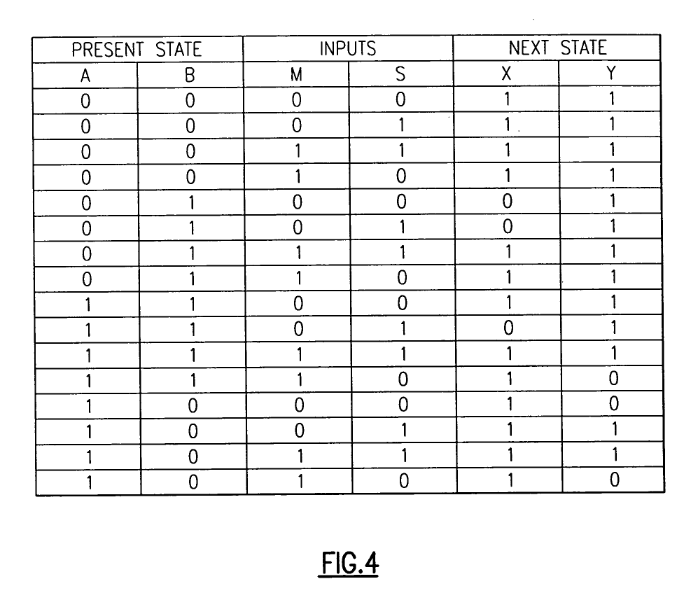

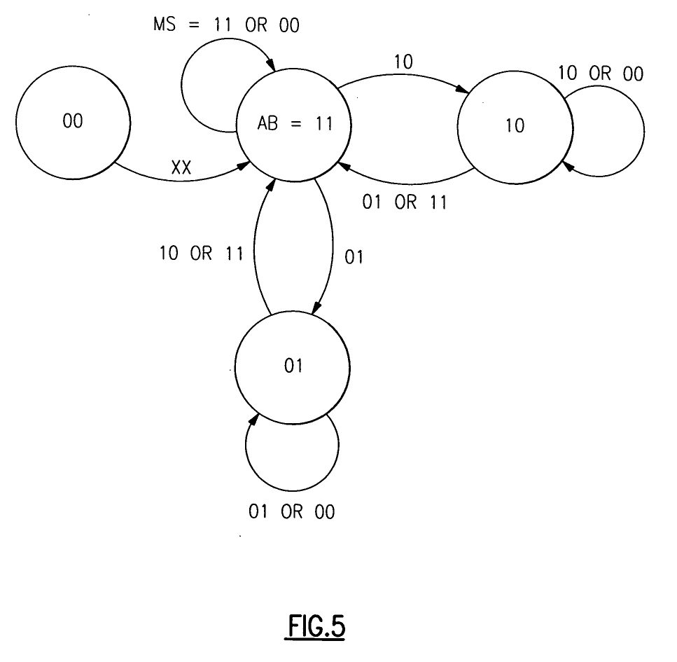

FIG. 3 depicts Kamaugh maps used to develop the first encoder logic 108 and the second encoder logic 208. FIG. 4 depicts an exemplary state transition table for the communication system of FIG. 1.

In operation, either first device 100 or second device 200 desires to send data to the other device. To send data, the transmitting device drives input/output pin to a logic low which, when the system 10 is in the idle state, drives the input/output pin of the receiving device to a logic low. This initiates transmission of data from the transmitting device to the receiving device.

FIG. 5 depicts an exemplary state diagram for the communication system 10 of FIG. 1. Upon initialization, the first state signal A and the second state signal B are both logic high and the state defaults to AB=11. This is the idle state and if first signal M and second signal S are both logic high (MS=11) this indicates that neither device is attempting to transmit to the other. If both first signal M and second signal S are logic low (MS=00), this indicates that both devices are attempting to transmit at the same time so the system 10 remains in the idle state. The MS=00 is considered a collision. The handling of collisions are protocol dependent.

If only the first device 100 is attempting to send data, the first device 100 drives the M signal to a logic low. The state transitions to AB=01 as shown in FIG. 5. Referring to FIG. 1, when in state AB=01, the value of not(A), the second drive signal for the second bus driver 204, is logic high thereby activating the second bus driver and pulling the second signal S to a logic low (ground). Also, the value of not(B), the first drive signal for the first bus driver 104, is logic low thereby deactivating the first bus driver 104 and it in a high impedance state, which allows for first device 100 to continue to pull second signal S to logic low. The system remains in state AB=01 and continues driving second signal S low until the first device 100 releases the bus, allowing the second signal to become a logic high.

To send a logic high from the first device 100 to the second device 200, the first device 100 releases the bus allowing the M signal to return to a logic high via pull up resistor 101. This results in the state transitioning to state AB=11 which in turn deactivates both bus drivers 104 and 204. The second signal S is no longer driven low, and returns to a logic high by virtue of pull up resistor 201. The first device 100 can continue sending logic low signals and logic high signals by driving the M signal as described above.

The second device 200 sends data to the first device 100 in a similar fashion. When the second device drives the S signal to a logic low, assuming the system state is AB=11, the system state transitions to state AB=10. The second device 200 sends logic low and logic high signals in a manner similar to that described above with reference to the first device 100. The second device 200 controls the first drive signals applied to first bus driver 104 to establish the value of the M signal.

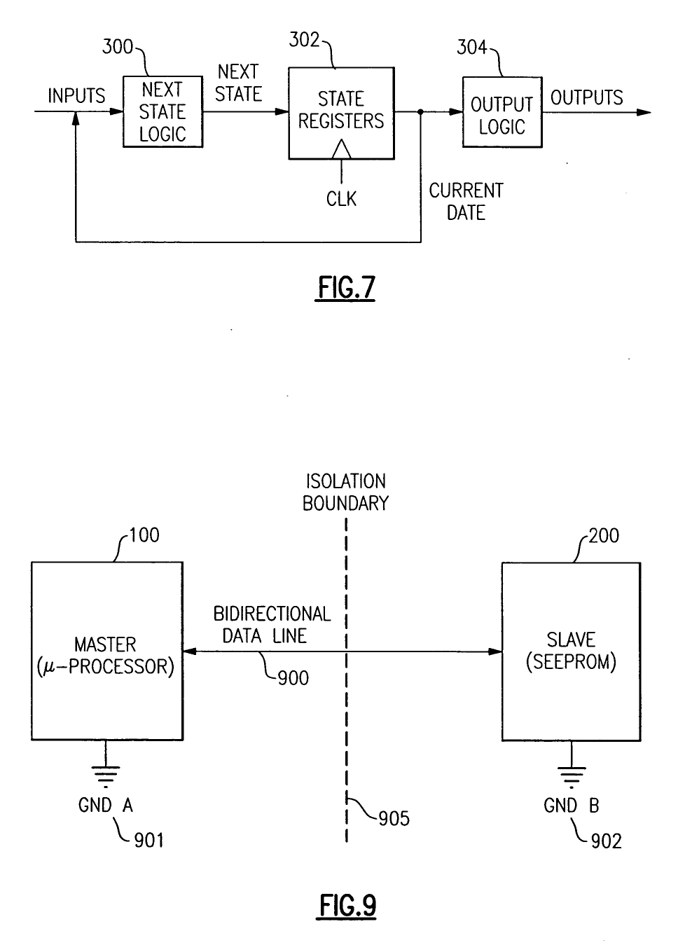

FIG. 6 shows a number of events and the corresponding changes in system state. As described above, either the first device 100 or the second device 200 initiates communication by driving the M signal or S signal, respectively, to a logic low. FIG. 7 is a high level block diagram of the communication system in an embodiment of the invention. As shown in FIG. 7, the current state is fed back as an input to the next state logic 300. This corresponds to the current first state A and current second state B being fed back to the first asynchronous encoder logic 108 and the second asynchronous encoder logic 208, respectively.

State registers 302 latch the next state as the current state and correspond to gates 10 and 210. The output logic 304 uses the current state information to generate the appropriate outputs. This corresponds to the inverted output on gates 10 and 210. The state machine provided by the communication system 10 provides the current state as a feedback directly to the input of the next state logic 300. This is contrasted with a typical Moore state machine. The communication system 10 provides synchronous feedback directly to the inputs of the combinational logic.

Communication system 10 enables asynchronous, half duplex, bidirectional communication without the use of a directional control line. Communication system 10 is also transparent to the first device 100 and second device 200 and autonomously determines the direction of communication. The first device 100 and second device 200 behave as if they are directly tied together by a copper wire. The communication system 10 may be implemented using individual logic elements, as part of an integrated circuit (such as a memory controller, serial communications multiplexer, or an interrupt arbitrator). The communication system 10 may also be as part of a larger system in a custom ASIC, FPGA, or CPLD. The communication system 10 provides a mechanism to separate the bidirectional signal into two unidirectional push-pull signals that can be routed and switched using standard logic gates. The system may also be used to create high level switching and routing functions such as multiplexers and demultiplexers.

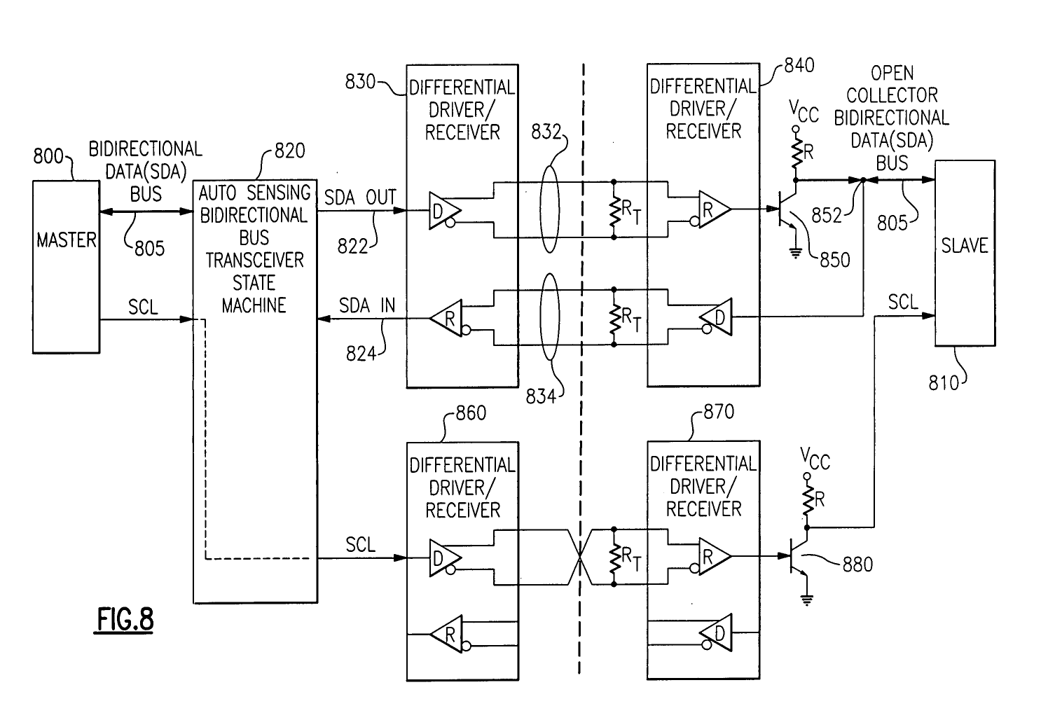

The separation mechanism of communication system 10 can further advantageously be employed in an enhanced communication system which extends the range of a bidirectional data communication bus from that presently available. One embodiment of this enhanced communication system is depicted in FIG. 8.

As shown, a first device 800, such as a master device, is to communicate with a second device 810, for example, a slave device, employing a bidirectional data bus 805 which comprises a single line data transmission bus. In this example, bidirectional data bus 805 is broken into two portions with one embodiment of an enhanced communication system being inserted therebetween. Specifically, an autosensing bidirectional bus transceiver state machine 820 is employed adjacent to the first device 800 for separating the single line bidirectional communication bus into a unidirectional transmit data communication bus (serial data out (SDA OUT)) 822 and a unidirectional receive data communication bus (serial data in (SDA IN)) 824. Autosensing bidirectional bus transceiver state machine 820 can, in one example, comprise the communication system components described above in connection with FIGS. 1-7, i.e., those components disposed between first device 100 and second device 200 of FIG. 1. The two unidirectional communication buses can be obtained by, for example, decomposing the connection at point S from the drain/collector of transistor 204 to input buffer 206. Once so modified, transistor 204 functions as an output buffer for SDA OUT, while pin 202 and buffer 206 comprise the separate SDA IN line. Each line is tied to a separate unidirectional pin. By splitting the bidirectional bus into two unidirectional buses/pins, an ability is provided to differentially drive the signals in different directions.

A differential communication subsystem comprising multiple differential drivers/receivers 830, 840, 860 & 870 is employed to extend the length of the unidirectional transmit and receive data communication buses 822, 824. As shown, differential driver/receiver 830 includes a driver D which drives serial transmit data across a half duplex differential communication bus 832 to a receiver R disposed within differential driver/receiver 840. Resistance RT comprises a conventional termination resistance for the differential communication bus. Serial receive data from second device 810 is driven by a differential driver D within differential driver/receiver 840 across a second half duplex differential communication bus 834 to a receiver R within differential driver/receiver 830 for output as the SDA IN (on the unidirectional receive data communication bus 824).

At a distal end of the differential communication subsystem, the SDA OUT signal gates a transistor 850, which in this example, converts the transmit data communication to an open collector transmit data communication with its base tied to Vcc across a resistor R. The SDA OUT communication and the SDA IN communication are recombined at a connect terminal 852 into, for example, an open collector bidirectional data bus 805, which is also connected to second device 810. Advantageously, state machine 820, the differential communication subsystem, and the recomposition circuitry are all transparent to first device 800 and second device 810, and there is no required data direction control bit or line. Consistent communication protocols are used throughout data transfers on the bidirectional data bus and the state machine a 820, differential communication subsystem and recomposition circuitry can be resident within the connection lines between the first device and the second device. [0043] A unidirectional, serial clock signal (SCL) is also shown in FIG. 8. This clock signal is passed through (or around) the state machine 820 and is differentially driven by differential driver/receiver 860 and 870 in order to extend the length of the clock bus. Since the serial clock signal is assumed to comprise open collector in this example, a transistor 880 is employed at the output of the differential circuitry to recompose the clock signal as an open collector clock signal. Because transistor 880 functions to invert the clock signal, the clock line is shown inverted between differential driver/receiver 860 and differential driver/receiver 870. A similar inversion is not required in the data lines since the inversion is handled by the above-described state machine of FIGS. 1-7.

Those skilled in the art will note from the above description that provided herein is a system and method to electrically isolate, for example, a half duplex open collector or open drain communication bus. Employing the state machine described in connection with FIGS. 1-7, a programmable logic device has the ability to allow for half duplex open collector or open drain communications to be implemented with a single line data transmission decomposed into a transmit communication bus and a receive communication bus. This takes full advantage of the architecture of programmable logic devices in that a bidirectional input/output buffer can be split as described herein into two pins, one being an input, the other serving as the output, and then simply wire dotting the pins further along the communications path to reestablish the bidirectional bus. Once the bidirectional communications bus is converted into a transmit communication bus and a receive communication bus, the opportunity arises to electrically isolate these buses via optoisolators. This allows for device 1 and device 2 to be referenced to unique electrical grounds, allowing for level translation and isolation. This allows for a significant extension of the range of an open collector or open drain bus while providing sharp rise times, exceeding specifications such as the I²C protocol specification. This greatly enhances the potential of a half duplex bidirectional communications bus, allowing for noise immune transmissions over great lengths. The circuitry of the present invention could be implemented in a distributed fashion (e.g., FPGA, discrete components, transceivers), or be fabricated into a single integrated circuit solution.

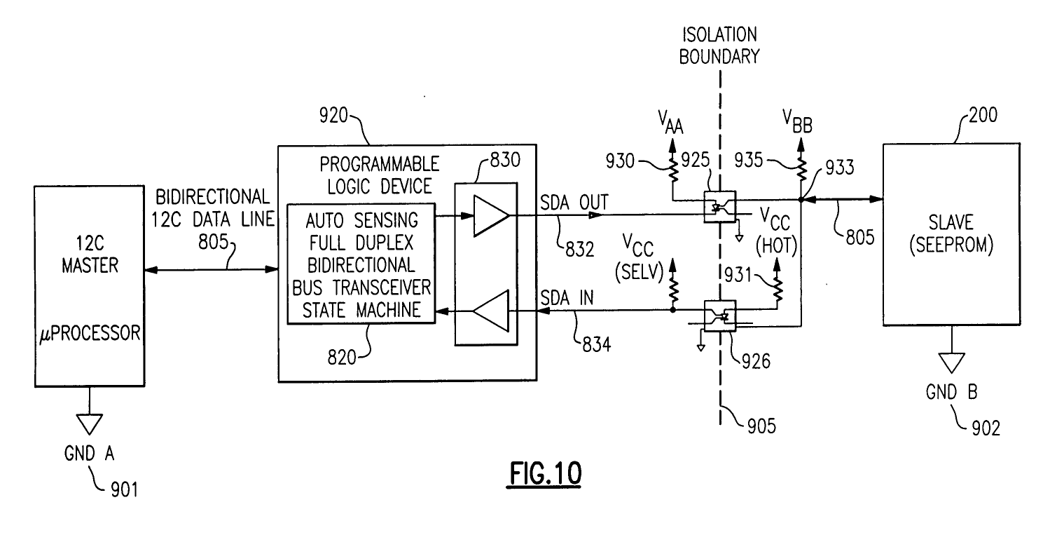

Referring to FIG. 9, a bidirectional data line 900 connects the master device 100 with the slave device 200 of FIG. 1. The bidirectional data line 900 represents the communication system 10 of FIG. 1, and may form an I²C bidirectional data line. The master 100 may be a microprocessor which is referenced to an GND A ground 901. The slave device 200 may be, for instance, an SEEPROM (Serial Electrically Erasable Programmable Read Only Memory) which is referenced to a GND B dc voltage at 902. Since these two devices (100 and 200) are referenced to different voltages, an isolation boundary 905 is formed, and any communications signals traveling on the bidirectional line 900 between the devices must safely cross this boundary 905.

Referring to FIG. 10, the master 100 is connected to the slave 200 by the communication system shown and discussed in connection with FIG. 8, with optical isolation devices, to be discussed. As previously discussed, the communications system includes a programmable logic device 920, which includes an auto sensing full duplex bidirectional bus transceiver state machine 820, as discussed in connection with FIG. 8. Also included is a differential driver/receiver 830, which provides an sda out conductor 832, and an sda in conductor 834. As discussed in connection with FIG. 9, the master device 100 is referenced to GND A ground at 901, and the slave device 200 is referenced to GND B dc at 902. As discussed in FIG. 9, an isolation boundary 905 is established between the two devices to isolate the ground differential. Optical isolation devices, al referred to herein as Optocouplers, 925 and 926 optically traverse the GND A boundary 905 in both directions. The crossing of the boundary is in a safe manner which is recognized by safety agencies such as UL. As previously explained, the state machine 820 is programmed inside of logic device 920 to split the bidirectional half duplex data into a unique transmit line 832 and a unique receive line 834. The anode of the light emitting diode of the optocoupler 925 on the master side of the isloation boundary 925 is connected through resistor 930 to Vaa voltage, and the anode of the optocoupler 236 on the slave side of the boundary 905 is connected to the Vbb voltage of the slave side through resistor 931. The collector of the photo receptor of the optocoupler 925 is connected to the cathode of the light emitting diode of the optocoupler 926 by a connection at 933 which are connected to a pull up resistor 935. Thus, sda out 832 and sda in 834 are wire dotted at 933 on the primary side and tied directly to the data line of the slave device 200. Further, bidirectional data is maintained. Additionally, latch-up immunity is provided in this design. Further, the existence of the logic device 920 and associated state machine 820 is transparent to both the master device 100 and slave device 200. Safe, transparent, bidirectional half duplex communications is thus established between two devices referenced to isolated ground planes without violating safety requirements. It should be noted that this invention is generically applicable to a multitude of systems with varying operational voltage potentials where bidirectional communications must be established between two devices.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for providing an interface between a master device referenced at a first voltage and a slave device referenced at a second voltage, said system comprising:
a bidirectional communications link between the master device and the slave device;
a bidirectional transceiver device in said communications link for decomposing bidirectional signals on said communications link into transmissions from the slave device to the master device onto a first bus, and transmissions from the master device to the slave device onto a second bus;
a first isolation device in said bidirectional link and connected to said first bus, said first isolation device for transmitting signals over said bidirectional link from said master device referenced at said first voltage to said slave device referenced at said second voltage; and
a second isolation device in said bidirectional link and connected to said second bus, said second isolation device for transmitting signals over said bidirectional link from said slave device referenced at said second voltage to said master device referenced at said first voltage.

2. The system of claim 1 wherein said first isolation and second isolation devices are optical isolation devices.

3. The system of claim 2 wherein said optical isolation devices each comprises a light emitting diode driven by a transmitting voltage and a photo receptor connected to receiving voltage for isolating the transmitting voltage from the receiving voltage.

4. The system of claim 2 wherein said first and second optical isolation devices are wire dotted to the bidirectional communications link in parallel with a pull-up resistor for carrying signals from the master device being sent to the slave device with signals being sent from the slave device to the master device over the bidirectional communications link.

5. The system of claim 1 wherein said first isolation device is connected in said bidirectional link between said bidirectional transceiver device and said slave device.

6. The system of claim 1 wherein said second isolation device is connected in said bidirectional link between said bidirectional transceiver device and said slave device.

7. A communications system comprising:
a master device for sending and receiving communication signals, said master device referenced at a first voltage;
a slave device for sending and receiving communications signals, said slave device referenced at a second voltage;
a bidirectional communications link for transmitting communications signals between said master device and said slave device;
a bidirectional transceiver device in said communications link for decomposing bidirectional signals on said communications link into transmissions from the slave device to the master device onto a first bus, and transmissions from the master device to the slave device onto a second bus;
a first isolation device in said bidirectional link and connected to said first bus, said first isolation device for transmitting signals over said bidirectional link from said master device referenced at said first voltage to said slave device referenced at said second voltage; and
a second isolation device in said bidirectional link and connected to said second bus, said second isolation device for transmitting signals over said bidirectional link from said slave device referenced at said second voltage to said master device referenced at said first voltage.

8. The system of claim 7 wherein said master device is a microprocessor.

9. The system of claim 7 wherein said slave device is a serial electrically erasable programmable read only memory device.

10. The system of claim 7 wherein said first isolation and second isolation devices are optical isolation devices.

11. The system of claim 10 wherein said optical isolation devices each comprises a light emitting diode driven by a transmitting voltage and a photo receptor connected to receiving voltage for isolating the transmitting voltage from the receiving voltage.

12. The system of claim 10 wherein said first and second optical isolation devices are wire dotted to the bidirectional communications link in parallel with a pull-up resistor for carrying signals from the master device being sent to the slave device with signals being sent from the slave device to the master device over the bidirectional communications link.

13. The system of claim 7 wherein said first isolation device is connected in said bidirectional link between said bidirectional transceiver device and said slave device.

14. The system of claim 7 wherein said second isolation device is connected in said bidirectional link between said bidirectional transceiver device and said slave device.

15. A method for providing an interface between a master device referenced at a first voltage and a slave device referenced at a second voltage, said method comprising:
transmitting communications signals on a bidirectional communications link between the master device and the slave device;
decomposing the bidirectional communications signals on said communications link into transmissions from the slave device to the master device onto a first bus, and transmissions from the master device to the slave device onto a second bus;
electrically isolating communications signals being transmitted from said master device referenced at said first voltage over the first bus from signals transmitted to said slave device referenced at said second voltage; and
electrically isolating communications signals being transmitted from said slave device referenced at said second voltage over the second bus from signals transmitted to said master device referenced at said first voltage.

16. The method of claim 15 wherein said electrically isolating is performed by optical isolation devices.

17. The method of claim 16 wherein said optical isolation devices each comprises a light emitting diode driven by a transmitting voltage and a photo receptor connected to a receiving voltage for isolating the transmitting voltage from the receiving voltage.

18. The method of claim 16 further comprising wire dotting said optical isolation devices to the bidirectional communications link in parallel with a pull-up resistor such that signals from the master device being sent to the slave device are transmitted with signals being sent from the slave device to the master device over the bidirectional communications link.
